(19) United States
(12) Patent Application Publication
(10) Pub. No.: US 2020/0319642 A1
(43) Pub. Date: Oct. 8, 2020

(54) GIMBAL CONTROL METHOD AND DEVICE, GIMBAL, AND UNMANNED AERIAL VEHICLE

(71) Applicant: SZ DJI TECHNOLOGY CO., LTD., Shenzhen (CN)

(72) Inventors: Shuai LIU, Shenzhen (CN); Yingzhi WANG, Shenzhen (CN); Zhendong WANG, Shenzhen (CN)

(21) Appl. No.: 16/903,878

(22) Filed: Jun. 17, 2020

Related U.S. Application Data
(63) Continuation of application No. PCT/CN2017/117668, filed on Dec. 21, 2017.

(51) Int. Cl. G05D 1/00; B64C 39/02; B64D 41/00; G05D 1/10; G01C 19/00; G01P 15/08

(52) U.S. Cl. CPC G05D 1/0094; B64C 39/024; B64D 41/00; B64C 2201/14; G01C 19/00; G01P 15/08; B64C 2201/027; G05D 1/101

(57) ABSTRACT

A gimbal is provided for an unmanned aerial vehicle (UAV). The gimbal includes a processor, a rotational axis mechanism, a motor for driving the rotational axis mechanism, and a first sensor for providing first attitude data of the gimbal. The processor is configured to obtain a first instruction to control movement of the gimbal; acquire the first attitude data from the first sensor; acquire second attitude data of the UAV that is connected to the gimbal; adjust a control direction of the first instruction based on the first attitude data and the second attitude data to obtain a second instruction for controlling the gimbal; and control movement of the motor using the second instruction to drive the rotational axis mechanism so as to realize the controlling of the gimbal.

### CROSS-REFERENCE TO RELATED APPLICATION

This application is a continuation of International Application No. PCT/CN2017/117668, filed Dec. 21, 2017, the entire content of which is incorporated herein by reference.

### COPYRIGHT NOTICE

A portion of the present disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of control technology and, more particularly, to a method and device for controlling a gimbal, a gimbal, and an unmanned aerial vehicle (UAV).

### BACKGROUND

With the development of the flight technology, aircrafts, such as unmanned aerial vehicles (UAVs), also known as drones, have evolved from military applications to civilian applications in more and more areas. Examples include UAV plant protection, UAV aerial photography, UAV forest fire alarm monitoring, etc. In addition, civilianization is also the future trend of UAV development.

A gimbal can be mounted on the lower part of an aircraft and provide a platform for carrying a load, fastening a load, adjusting the attitude of a load randomly (for example, changing the height, tilt, and/or direction of a load), or maintaining a stable attitude of a load. For example, when a load is a photographing device, it may be carried by a gimbal to achieve stable, smooth, and multi-angle shooting. However, a gimbal is usually fixed on the lower part of an aircraft, which limits the function of a load.

Therefore, it is desirable to have flexible gimbal mounting places on an aircraft and a simple way to control a gimbal when the gimbal is mounted in different positions.

### SUMMARY

In accordance with the present disclosure, a gimbal is provided for an unmanned aerial vehicle (UAV). The gimbal includes a processor, a rotational axis mechanism, a motor for driving the rotational axis mechanism, and a first sensor for providing first attitude data of the gimbal. The processor is configured to obtain a first instruction to control movement of the gimbal; acquire the first attitude data from the first sensor; acquire second attitude data of the UAV that is connected to the gimbal; adjust a control direction of the first instruction based on the first attitude data and the second attitude data to obtain a second instruction for controlling the gimbal; and control movement of the motor using the second instruction to drive the rotational axis mechanism so as to realize the controlling of the gimbal.

Also in accordance with the present disclosure, a UAV includes a communication system, a power system, a flight control system, a gimbal, and a sensing system. The communication system is configured to obtain instructions to control movement of the UAV. The flight control system provides, based on the instructions from the communication system, driving signals to the power system. The power system drives the UAV based on the driving signals from the flight control system. The gimbal includes a first sensor and the sensing system includes a second sensor. The gimbal further includes a processor, a rotational axis mechanism, and a motor for driving the rotational axis mechanism. The first sensor is configured to acquire first attitude data of the gimbal. The processor is configured to obtain a first instruction to control movement of the gimbal; obtain the first attitude data from the first sensor; obtain second attitude data from the second sensor; adjust a control direction of the first instruction based on the first attitude data and the second attitude data to obtain a second instruction for controlling the gimbal; and control movement of the motor using the second instruction to drive the rotational axis mechanism so as to realize the controlling of the gimbal.

Also in accordance with the present disclosure, a gimbal for a UAV includes a processor, a rotational axis mechanism, a motor for driving the rotational axis mechanism, and a first sensor for providing first attitude data of the gimbal. The processor is configured to obtain a first instruction to control movement of the gimbal; acquire the first attitude data from the first sensor; acquire second attitude data of the UAV connected to the gimbal; determine whether directions of a body coordinate system of the unmanned aerial vehicle are same as respective corresponding directions of a body coordinate system of the gimbal; in response to all of the directions of the body coordinate system of the unmanned aerial vehicle being same as all of the respective corresponding directions of the body coordinate system of the gimbal, use the first instruction to control movement of the motor to drive the rotational axis mechanism so as to realize controlling of the gimbal; and in response to one of the directions of the body coordinate system of the unmanned aerial vehicle being different from a corresponding one of the directions of the body coordinate system of the gimbal: adjust a control direction, corresponding to the one of the directions, of the first instruction based on the first attitude data and the second attitude data to obtain a second instruction for controlling the gimbal; and control movement of the motor using the second instruction to drive the rotational axis mechanism so as to realize controlling of the gimbal.

### BRIEF DESCRIPTION OF THE DRAWINGS

FIG. 1 illustrates a schematic structural diagram of a gimbal according to an exemplary embodiment of the present disclosure;

FIG. 2 illustrates a schematic diagram of how a gimbal is mounted to an unmanned aerial vehicle (UAV) according to another exemplary embodiment of the present disclosure;

FIG. 3 illustrates a schematic diagram of how a gimbal is mounted to a UAV according to another exemplary embodiment of the present disclosure;

FIG. 4 is a schematic flow chart of a gimbal control method according to an exemplary embodiment of the present disclosure;

FIGS. 5A-5D respectively illustrate schematic diagrams of relative attitude between a UAV and a gimbal according to another exemplary embodiment of the present disclosure;

FIG. 6A is a schematic diagram of a UAV body coordinate system according to an exemplary embodiment of the present disclosure;

FIG. 6B is a schematic diagram of a gimbal body coordinate system according to an exemplary embodiment of the present disclosure;

FIG. 7A is another schematic diagram of a UAV body coordinate system according to another exemplary embodiment of the present disclosure;

FIG. 7B is another schematic diagram of a gimbal body coordinate system according to another exemplary embodiment of the present disclosure;

FIG. 8 illustrates a schematic structural diagram of a control device according to another exemplary embodiment of the present disclosure; and

FIG. 9 illustrates a schematic diagram of a UAV and a terminal device according to another exemplary embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Exemplary embodiments will be described with reference to the accompanying drawings, in which the same numbers refer to the same or similar elements unless otherwise specified. Features in various embodiments may be combined, when there is no conflict.

A gimbal can carry a load (for example, a photographing device) and be used for fixing a load, changing the height, inclination, and/or direction of a load, or for keeping a load in a fixed attitude.

A gimbal in one embodiment of the present disclosure may be mounted on a mobile device, for example, on an unmanned aerial vehicle (UAV) or a motor vehicle.

A gimbal in one embodiment of the present disclosure may be used to carry devices other than a photographing device, such as a spectrometer, a microwave antenna for a radar, etc. A gimbal may also have other names, for example, a load support rack, etc. Embodiments of the present disclosure do not specifically limit any specific names for the gimbal.

FIG. 1 schematically shows a structural diagram of a gimbal 100 consistent with the present disclosure. As shown in FIG. 1, the gimbal 100 may include a base 110, a load support 140, a yaw axis mechanism 122, a roll axis mechanism 124, a pitch axis mechanism 126, a yaw axis motor 132, a roll axis motor 134, and a pitch axis motor 136. The yaw axis motor 132 is installed on the base 110 for driving rotation of the yaw axis mechanism 122, the roll axis motor 134 is installed on the rolling axis mechanism 124 for driving rotation of the roll axis mechanism 124, and the pitch axis motor 136 is installed on the pitch axis mechanism 126 for driving rotation of the pitch axis mechanism 126.

In some embodiments, a gimbal may also include only one or two of the rotational axis mechanisms. In addition, although as shown in FIG. 1, the yaw axis mechanism 122 is connected to one end of the roll axis mechanism 124, the other end of the roll axis mechanism 124 is connected to the pitch axis mechanism 126, and the load support 140 is directly connected to the pitch axis mechanism 126, embodiments of the present disclosure are not limited to this configuration. The yaw axis mechanism 122, the roll axis mechanism 124, and the pitch axis mechanism 126 may also be connected in other orders and form other arrangements.

The load support 140 may be used to support a load 199 and certain sensors. For example, an inertial sensor, such as at least one of an accelerometer or a gyroscope, may be mounted on the load support 140.

The gimbal 100 shown in FIG. 1 may be mounted on a mobile device (for example, a UAV) through the base 110. The gimbal 100 may receive power or send and receive electronic signals through the base 110, and may also send and receive wireless signals.

A processor may be installed in the base 110 for processing the input control instructions, and/or sending and receiving signals, etc.

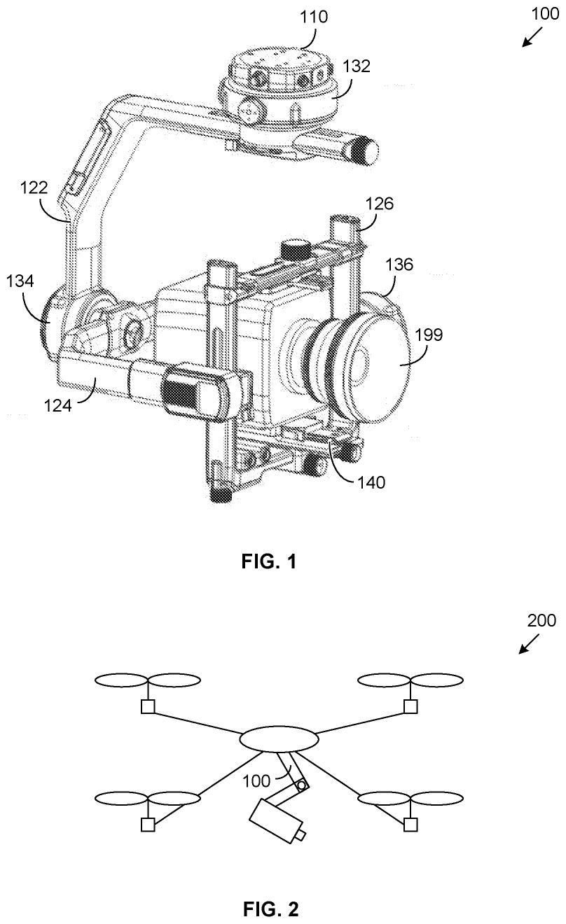

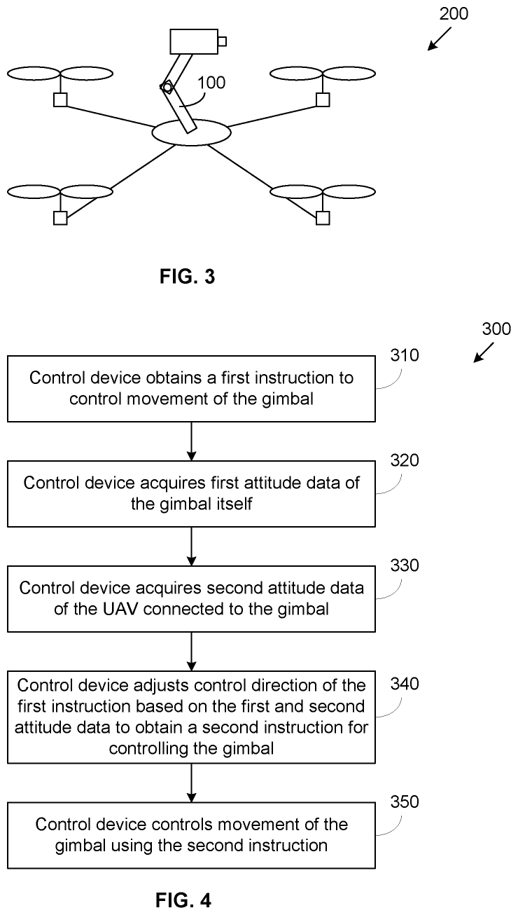

Taking a mobile device like a UAV as an example. The gimbal 100 may be mounted on the bottom of the UAV through the base 110. As shown in FIG. 2, the gimbal 100 may be disposed on the bottom of the UAV 200. In some embodiments, the gimbal 100 may also be mounted on the top of the UAV 200 through the base 110. For example, as shown in FIG. 3, the gimbal 100 is fixed on the upper part of the UAV 200. In some embodiments, the gimbal 100 may also be mounted in any positions other than the top or bottom of the UAV 200.

When a mounting position of a gimbal is flexible, it may increase the difficulty for a user to control the gimbal. For example, when the attitude of a UAV remains unchanged and a gimbal is mounted on the lower part of the UAV, if a user wants the gimbal to move upwards, the user may turn a joystick of the pitch axis upwards; and if the user wants the gimbal to rotate clockwise, the user may turn a joystick of the yaw axis to the right. However, when a gimbal is mounted on the upper part of a UAV and a user wants the gimbal to move upwards, the user needs to turn the joystick of the pitch axis downwards; and when the user wants the gimbal to rotate clockwise, the user needs to turn the joystick of the yaw axis to the left.

Consequently, a user needs to adjust control instructions according to the position of a gimbal on a UAV and then input the adjusted control instructions, making gimbal control complicated and prone to errors.

Therefore, according to embodiments of the present disclosure, the following gimbal control method 300 is provided to minimize the complexity of gimbal control and reduce control errors caused by a user.

FIG. 4 illustrates a schematic flow chart of the gimbal control method 300 consistent with the present disclosure. The method 300 may include at least a part of the following content and may be implemented by a control device. The control device may be installed in a gimbal, or alternatively, the control device may be installed in another device. For example, the control device may be installed in a UAV and controlled by the UAV's flight control system.

At 310, the control device obtains a first instruction to control movement of the gimbal.

In some embodiments, the control device may obtain the first instruction from a terminal device (for example, a remote control device or a mobile phone carrying a control application, etc.), or obtain the first instruction from a software development kit (SDK).

Specifically, a user may input an instruction to control movement of the gimbal through a terminal device in real time; or the user may write an instruction in a SDK to control movement of the gimbal, and the control device may read the SDK to obtain the user's instruction for controlling movement of the gimbal.

In some embodiments, a control device may obtain multiple instructions inputted by a user; and synthesizes the multiple instructions to obtain a first instruction.

In some embodiments, the multiple instructions may include instructions input by a user through a terminal device and/or instructions written through a SDK.

Specifically, a user may input a control instruction to the control device to control movement of the gimbal through multiple ways. For example, a user may input an instruction through a SDK once, and adjust the instruction input through the SDK in real time through a terminal device. After receiving multiple instructions, the control device may process the multiple instructions, such as implementing synthetic processing. Specifically, the speed vector in the instructions may be processed in an additive manner, or a previously input instruction may be substituted by an instruction that is input at a later time.

At 320, the control device acquires first attitude data of the gimbal itself. In some embodiments, a first sensor may be mounted on the gimbal (for example, mounted on the load support 140 as shown in FIG. 1), and the control device may obtain first attitude data through the first sensor provided on the gimbal.

In some embodiments, the first sensor may include at least one of an accelerometer or a gyroscope. Optionally, the first sensor may also be another sensor. Sensors mounted on the gimbal are not specifically limited in embodiments of the present disclosure.

In some embodiments, the first attitude data may be used to characterize directions of the gimbal body coordinate system, i.e., the body coordinate system of the gimbal.

In some embodiments, the gimbal body coordinate system is a three-dimensional (3D) orthogonal coordinate system that follows the right-hand rule. The origin of the coordinate system is located at the center of gravity of the gimbal. The OX axis is parallel to the axis of a photographing device (e.g., a direction of the photographing device's zoom) and points to the front of the photographing device (e.g., a direction which the lens faces). The OY axis is perpendicular to the axis of the photographing device and points to the right of the photographing device, and the OZ axis is perpendicular to the XOY plane and points below the photographic device.

When determining a gimbal body coordinate system, the relative positional relationship among the yaw, roll, and pitch axis mechanisms is under certain situation, and the positional relationship between the yaw, roll, and pitch axis mechanisms and the base is also under certain situation. Hence, the criteria remain consistent when the gimbal body coordinate system is determined in applications.

In some embodiments, directions of a gimbal body coordinate system may be directions of the three axes of the gimbal body coordinate system.

In some embodiments, for a gimbal according to embodiments of the present disclosure, the establishment of a gimbal body coordinate system may also be based on other ways, for example, a 3D orthogonal coordinate system following the left-hand rule, or a 3D orthogonal coordinate system following the right-hand rule with an OX axis pointing to the back of a photographic device.

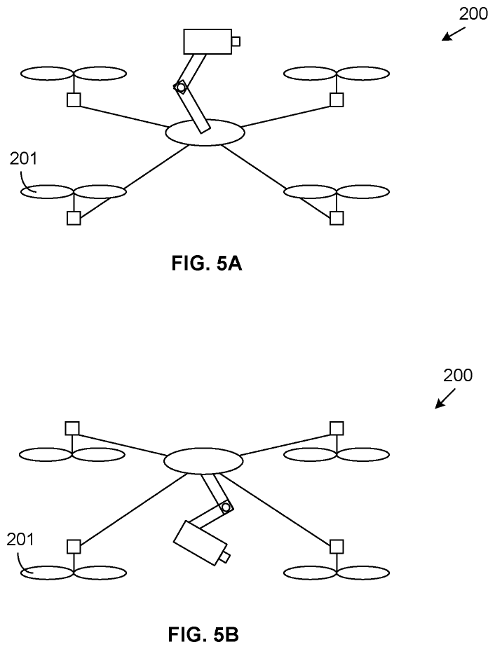

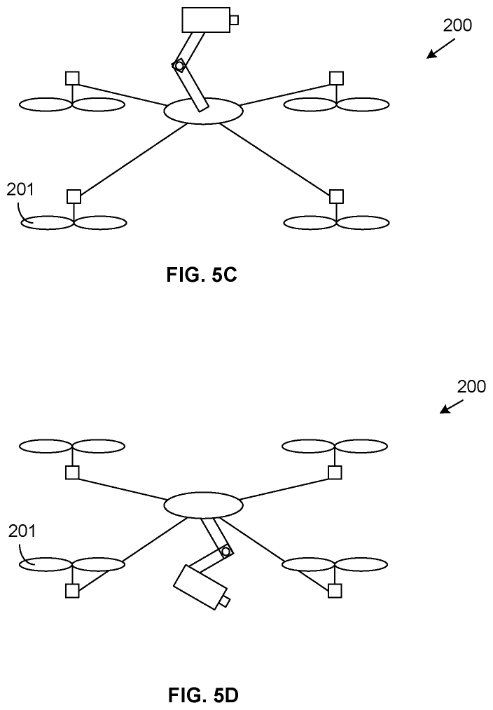

In some embodiments, directions of a gimbal body coordinate system may be arranged with respect to directions of the geodetic coordinate system. FIGS. 5A-5D illustrate schematic diagrams of relative attitude between a UAV 200 and a gimbal consistent with the present disclosure, where the UAVs are upright in FIGS. 5A and 5D, and are upside down in FIGS. 5B and 5C, which may be determined by the attitude of a propeller 201.

For example, as shown in FIGS. 5A and 5B, although the gimbals are both mounted on the top of the UAVs, since the attitudes of the UAVs are different, directions of the gimbal body coordinate systems are different with respect to the geodetic coordinate system. Similarly as shown in FIGS. 5C and 5D, although the gimbals are both mounted on the bottom of the UAVs, since the attitudes of the UAVs are different, directions of the gimbal body coordinate systems are different with respect to the geodetic coordinate system. Also similarly as shown in FIGS. 5A and 5C, although the gimbals are mounted on the top and bottom of the UAVs respectively, since the attitudes of the UAVs are different, directions of the gimbal body coordinate systems are the same with respect to the geodetic coordinate system. Also similarly as shown in FIGS. 5B and 5D, although the gimbals are mounted on the top and bottom of the UAVs respectively, since the attitudes of the UAVs are different, directions of the gimbal body coordinate systems are the same with respect to the geodetic coordinate system.

In some embodiments, directions of a gimbal body coordinate system may also be arranged with respect to a UAV body coordinate system, i.e., a body coordinate system of the UAV on which the gimbal is mounted.

In some embodiments, a UAV body coordinate system may be a 3D orthogonal coordinate system that follows the right-hand rule. The origin of the coordinate system is located at the center of gravity of the UAV. The OX axis is located in a reference plane of the UAV and parallel to the fuselage axis and points to the front of the UAV, the OY axis is perpendicular to the UAV reference plane and points to the right of the UAV, and the OZ axis is perpendicular to the XOY plane and in the reference plane of the UAV and points below the UAV.

In some embodiments, a UAV body coordinate system may also be configured according to other ways, for example, a 3D orthogonal coordinate system following the left-hand rule, or a 3D orthogonal coordinate system following the right-hand rule with an OX axis pointing to the back of the UAV.

At 330, the control device obtains second attitude data of the UAV connected to the gimbal.

In some embodiments, a second sensor may be installed on the UAV, and the second attitude data may be obtained through the second sensor. In some embodiments, the second sensor may include at least one of an accelerometer or a gyroscope. Alternatively, the second sensor may also be a sensor other than an accelerometer and a gyroscope, which is not specifically limited in embodiments of the present disclosure.

In some embodiments, the second attitude data may be used to characterize directions of a UAV body coordinate system.

In some embodiments, directions of a UAV body coordinate system may be directions of the three axes of the UAV body coordinate system.

In some embodiments, directions of a UAV body coordinate system may be configured with respect to the geodetic coordinate system.

For example, directions of the UAV body coordinate system of FIG. 5A and corresponding directions of the UAV body coordinate system of FIG. 5D are the same; and directions of the UAV body coordinate system of FIG. 5B and corresponding directions of the UAV body coordinate system of FIG. 5C are the same, too. However, the directions of the UAVs' body coordinate systems of FIGS. 5A and 5D are different from the directions of the UAVs' body coordinate systems of FIGS. 5B and 5C.

At 340, the control device may adjust a control direction of the first instruction based on the first attitude data and the second attitude data to obtain a second instruction for controlling the gimbal.

In some embodiments, in order to get the second instruction, the control device may adjust a control direction of the first instruction based on directions of the UAV body coordinate system and corresponding directions of the gimbal body coordinate system, and then obtain an adjusted control direction with respect to the gimbal body coordinate system.

Specifically, control instructions of the gimbal may be configured with respect to the UAV body coordinate system. For example, a user may input control instructions through a joystick controlling the gimbal, direct flight control through an application (app), and the control device may combine the instructions to obtain an overall instruction with respect to the UAV body coordinate system. Then, based on the attitude data of the UAV and the attitude data of the gimbal, the gimbal may determine the relative attitude between the UAV and the gimbal, adjust the overall instruction using an adjustment matrix, obtain an adjusted instruction with respect to the gimbal body coordinate system, calculate an output instruction, and send the output instruction to a closed-loop module.

In some embodiments, an adjustment matrix may be obtained based on the first attitude data and the second attitude data by, for example, the control device. The control device may use the adjustment matrix to adjust a control direction of the first instruction to obtain the second instruction.

In some embodiments, the adjustment matrix may include three elements, which may be used to adjust directions of the velocity components, in the OX axis, the OY axis, and the OZ axis, of the first control instruction.

In some embodiments, the value of each element of the adjustment matrix may be related to the directions of the UAV body coordinate system and the directions of the gimbal body coordinate system.

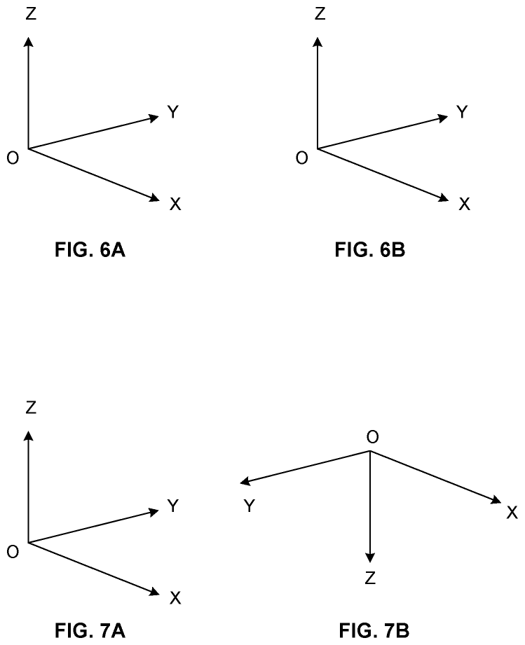

FIGS. 6A, 6B, 7A, and 7B illustrate schematic diagrams of a UAV body coordinate system or a gimbal body coordinate system consistent with the present disclosure. FIG. 6A may reflect a UAV body coordinate system and FIG. 6B may reflect a gimbal body coordinate system, which may correspond to the scenario illustrated in FIG. 5D as an example. Directions of the coordinate system shown in FIG. 6A and corresponding directions of the coordinate system shown in FIG. 6B are the same. As such, values of the three elements in the adjustment matrix may all be 1, and there is no need to adjust a control direction of the first instruction.

In another example, corresponding to the scenario shown in FIG. 5A, a UAV body coordinate system is shown in FIG. 7A and a gimbal body coordinate system is shown in FIG. 7B. The direction of the OX axis of the coordinate system shown in FIG. 7A and the direction of the OX axis of the coordinate system shown in FIG. 7B are the same, while the directions of the OY and OZ axes of the coordinate system shown in FIG. 7A are opposite to the directions of the OY and OZ axes of the coordinate system shown in FIG. 7B, respectively. The values of the elements of the adjustment matrix may be 1, −1, −1. The first element is used to adjust the OX-axis control direction of the first instruction, the second element is used to adjust the OY-axis control direction of the first instruction, and the third element is used to adjust the OZ-axis control direction of the first instruction.

Optionally, values of the elements of the adjustment matrix are not limited to 1 and −1, and may be related to an angle between an axis of the gimbal body coordinate system and a corresponding axis of the UAV body coordinate system.

In some embodiments, although directions are adjusted by the adjustment matrix separately, a direction of the speed of the second instruction may be a vector sum of speeds in all directions after the adjustment is completed.

In some embodiments, when at least one direction of a UAV body coordinate system is opposite to the corresponding direction of a gimbal body coordinate system, a control direction corresponding to the at least one direction of the first instruction is reversed to obtain the second instruction.

For example, the scenario as shown in FIG. 5A may correspond to a UAV body coordinate system shown in FIG. 7A and a gimbal body coordinate system shown in FIG. 7B. The direction of the OX axis of FIG. 7A and the direction of the OX axis of FIG. 7B are the same, while the directions of the OY and OZ axes of FIG. 7A are opposite to the directions of the OY and OZ axes of FIG. 7B, respectively. Hence, the control directions of the first instruction corresponding to the OY and OZ axes are reversed respectively when the first instruction is converted to the second instruction.

At 350, the control device may control movement of the gimbal using the second instruction.

Therefore, a control direction of an instruction, which controls the movement of a gimbal, may be adjusted using attitude data of a UAV and a gimbal. When the gimbal is mounted in a different position of the UAV, a control direction of an instruction may be automatically adjusted according to the attitude data of the gimbal corresponding to the position, which represents an automatic switching strategy. As there is no need for manual adjustment and manual setting, the complexity of gimbal rotation control may be reduced and control errors caused by a user may be minimized.

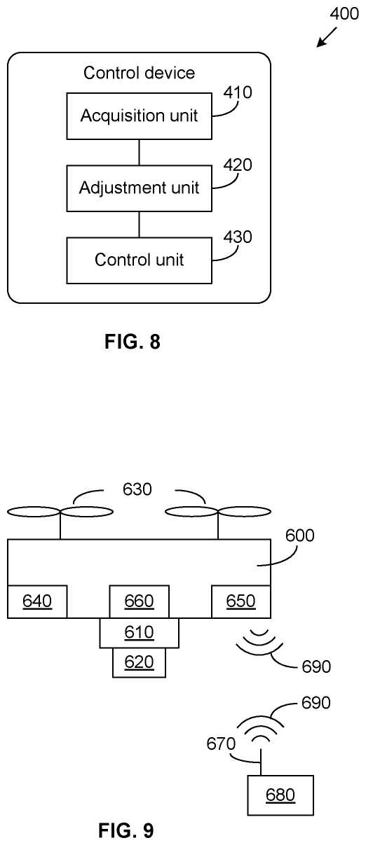

FIG. 8 schematically shows a structural block diagram of a control device 400 consistent with the present disclosure. As shown in FIG. 8, the control device 400 may include an acquisition unit 410, an adjustment unit 420, and a control unit 430.

The acquisition unit 410 may be configured to obtain a first instruction for controlling the movement of a gimbal; obtain first attitude data of the gimbal; and obtain second attitude data of a UAV connected to the gimbal. The adjusting unit 420 may be configured to adjust a control direction of the first instruction based on the first attitude data and the second attitude data to obtain a second instruction for controlling the gimbal. The control unit 430 may be configured to use the second instruction to control the movement of the gimbal.

In some embodiments, the acquisition unit 410 may be configured to obtain a first instruction for controlling the movement of a gimbal; obtain first attitude data of the gimbal; and obtain second attitude data of a UAV connected to the gimbal. The control unit 430 may be configured to determine whether directions of the UAV body coordinate system are the same as respective corresponding directions of the gimbal body coordinate system. When all the directions of the UAV body coordinate system are the same as the respective corresponding directions of the gimbal body coordinate system, the control system may be configured to use the first instruction to control movement of the gimbal. When at least one direction of the UAV body coordinate system and the corresponding direction of the gimbal body coordinate system are different, the adjusting unit 420 may be configured to adjust a control direction corresponding to the at least one direction of the first instruction to obtain a second instruction. Then, the control unit 430 may be configured to use the second instruction to control movement of the gimbal.

In some embodiments, the acquisition unit 410 may be configured to obtain a first instruction for controlling the movement of a gimbal and obtain first attitude data of the gimbal. The first instruction corresponds to the geodetic coordinate system. The first attitude data is obtained (e.g., by measurement or using existing attitude data) corresponding to the geodetic coordinate system, too. The adjusting unit 420 may be configured to generate a second instruction based on the first instruction and the first attitude data. The second instruction corresponds to the gimbal body coordinate system. For example, a control direction corresponding to at least one direction of the first instruction may be adjusted. The adjusted control direction corresponds to the gimbal body coordinate system. Then, the control unit 430 may be configured to use the second instruction to control movement of the gimbal.

In some embodiments, the acquisition unit 410 may be further configured to obtain the first attitude data through a first sensor mounted on the gimbal.

In some embodiments, the first sensor may be at least one of an accelerometer or a gyroscope.

In some embodiments, the acquisition unit 410 may be further configured to obtain the second attitude data through a second sensor installed on a UAV.

In some embodiments, the second sensor may be at least one of an accelerometer or a gyroscope.

In some embodiments, the adjusting unit 420 may be further configured to obtain an adjustment matrix based on the first attitude data and the second attitude data; and use the adjustment matrix to adjust a control direction of the first instruction to obtain the second instruction.

In some embodiments, the first attitude data may be used to characterize a direction of a gimbal body coordinate system, and the second attitude data may be used to characterize a direction of a UAV body coordinate system.

In some embodiments, the first instruction corresponds to a UAV body coordinate system. The adjustment unit 420 may be further configured to based on directions of the UAV body coordinate system and the corresponding directions of the gimbal body coordinate system, adjust a control direction of the first instruction to an adjusted control direction to obtain the second instruction. The adjusted control direction corresponds to the gimbal body coordinate.

In some embodiments, when at least one direction of the UAV body coordinate system and the corresponding direction of the gimbal body coordinate system are opposite, the adjustment unit 420 is further configured to reverse a control direction corresponding to the at least one direction of the first instruction to obtain the second instruction.

In some embodiments, the acquisition unit 410 is further configured to obtain multiple instructions inputted by a user; and synthesize the multiple instructions to obtain the first instruction.

In some embodiments, the multiple instructions include instructions inputted through a terminal device and/or instructions written through a SDK.

The control device 400 may implement a method consistent with the disclosure, such as the control method 300 described above in connection with FIG. 4. For brevity, details are not described herein again.

Embodiments of the present disclosure provide a gimbal. The gimbal may include a processor, a rotational axis mechanism, a motor for driving the rotational axis mechanism, and a first sensor.

In some embodiments, the gimbal may be the gimbal 100 shown in FIG. 1. The processor may be disposed in the base 110, or disposed in another position. The rotational axis mechanism may include one or more of the rotational axis mechanisms 122, 124, and 126 shown in FIG. 1. The motor may include one or more of the motors 132, 134, and 136 shown in FIG. 1. The first sensor may be mounted on the load support 140, or mounted in another position.

The processor of the gimbal may implement a method consistent with the disclosure, such as the gimbal control method 300 described above in connection with FIG. 4. For brevity, details are not described herein again.

In some embodiments, a gimbal in embodiments of the present disclosure may be mounted on a mobile device. The mobile device may be movable in any suitable environment, for example, in the air (for example, a fixed-wing aircraft, a rotary-wing aircraft, or an aircraft with neither a fixed-wing nor a rotary-wing), underwater (for example, a ship or a submarine), on land (for example, a car or a train), in space (e.g., a space plane, a satellite, or a probe), and any combination of these environments. The mobile device may be an aircraft, such a UAV. In some embodiments, the mobile device may carry a living body, such as a human or an animal. The following uses a UAV 600 to explain some embodiments.

FIG. 9 shows a schematic diagram of the UAV 600 and a terminal device 680 consistent with the present disclosure. As shown in FIG. 9, the UAV 600 may include a gimbal 610 and a camera 620. The UAV 600, as a device carrying the gimbal 610, is illustrated in FIG. 9 for descriptive purposes only. The camera 620 may be connected to the UAV through the gimbal 610. The UAV 600 may further include a power system 630, a sensing system 640, a communication system 650, and a flight control system 660.

The power system 630 may include an electronic speed controller (ESC), one or more propellers, and one or more electric motors corresponding to the one or more propellers. The motors and propellers may be mounted on corresponding arms. The ESC may be used to receive a driving signal generated by the flight control system 660, and provide a driving current to the motor according to the driving signal to control the speed and/or steering of the motor. The motor is used to drive the propeller to rotate, thereby providing power for the UAV's flight, which enables the UAV to achieve motion of one or more degrees of freedom. In some embodiments, a UAV may rotate about one or more axes of rotation. For example, the axes of rotation may include a roll axis, a pan axis, and/or a pitch axis. The motor may be a DC motor or an AC motor. In addition, the motor may be a brushless motor or a brushed motor.

The sensing system 640 may be used to measure attitude information of the UAV, that is, the position information and status information about the UAV in the air, such as a 3D position, a 3D angle, a 3D velocity, a 3D acceleration, a 3D angular velocity, etc. The sensing system 640 may include, for example, at least one of a gyroscope, an accelerometer, an electronic compass, an inertial measurement unit (IMU), a vision sensor, a global positioning system (GPS), or a barometer. The flight control system 660 may be used to control the UAV's flight. For example, it may control the UAV's flight based on the attitude information measured by the sensing system 640. The flight control system 660 may control the UAV according to pre-programmed program instructions, or it may control the UAV by responding to one or more control instructions from a control device. The sensing system 640 may include a second sensor according to some embodiments of the present disclosure, and the second sensor may be configured to acquire attitude data of the UAV. The second sensor may include at least one of a gyroscope or an accelerometer.

The communication system 650 may communicate with the terminal device 680 that has a communication system 670 through wireless signals 690. The communication system 650 and communication system 670 may include multiple transmitters, receivers, and/or transceivers for wireless communication. The wireless communication here may be a one-way communication, for example, the UAV 600 may only send data to the terminal device 680. The wireless communication may also be two-way communication. For example, data may be sent from the UAV 600 to the terminal device 680, and data may be sent from the terminal device 680 to the UAV 600.

The flight control system 660 may control the flight of the UAV 600 based on an instruction obtained by the communication system 650 and output a driving signal to the power system 630. In addition, the flight control system 660 may also feedback the current flight status to the terminal device 680 through the communication system 650.

In some embodiments, the gimbal 610 may include a processor, a first sensor, a rotational axis mechanism, and a motor for driving the rotational axis mechanism. The first sensor may be configured to obtain first attitude data of the gimbal. The processor may perform operations consistent with the disclosure, such as those described above in connection with FIG. 4 to obtain a second instruction to control movement of the motor. The motor runs according to control signals from the processor and drives movement of a rotational axis mechanism.

In some embodiments, the terminal device 680 may provide control data for one or more UAVs 600, gimbals 610, and cameras 620, and may receive information sent by the one or more UAVs 600, gimbals 610, and cameras 620. Control data provided by the terminal device 680 may be used to control the status of the one or more UAVs 600, gimbals 610, and the cameras 620. In some embodiments, the gimbal 610 and camera 620 each may include a communication module for communicating with the terminal device 680.

For the gimbal 610 shown in FIG. 9, reference may be made to descriptions of gimbals illustrated in the embodiments above. For brevity, details of the gimbal 610 are not repeated here.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

People skilled in the art may understand that for convenient and concise descriptions, above examples and illustrations are based only on the functional modules. In practical applications, the functions may be distributed to and implemented by different functional modules according to the need. That is, the internal structure of a device may be divided into different functional modules to implement all or partial functions described above. The specific operational process of a device described above may refer to the corresponding process in the embodiments described above, and no further details are illustrated herein.

Further, it should be noted that the above embodiments are used only to illustrate the technical solutions of the present disclosure and not to limit it to the present disclosure. Although the present disclosure is described in detail in the light of the foregoing embodiments, those of ordinary skill in the art should understand that they can still modify the technical solutions recorded in the preceding embodiments, or they can perform equivalent replacements for some or all of the technical features. The modifications or substitutions, however, do not make the nature of the corresponding technical solutions out of the scope of the technical solutions of the present disclosure.

What is claimed is:

1. A gimbal for an unmanned aerial vehicle, comprising:
a processor;
a rotational axis mechanism;
a motor for driving the rotational axis mechanism; and
a first sensor for providing first attitude data of the gimbal;
wherein the processor is configured to:
obtain a first instruction to control movement of the gimbal;
acquire the first attitude data from the first sensor;
acquire second attitude data of the unmanned aerial vehicle connected to the gimbal;
adjust a control direction of the first instruction based on the first attitude data and the second attitude data to obtain a second instruction for controlling the gimbal; and
control movement of the motor using the second instruction to drive the rotational axis mechanism so as to realize controlling of the gimbal.

2. The gimbal according to claim 1, wherein the first sensor includes an accelerometer or a gyroscope.

3. The gimbal according to claim 1, the processor is further configured to:
acquire the second attitude data through a second sensor mounted on the unmanned aerial vehicle.

4. The gimbal according to claim 3, wherein the second sensor includes an accelerometer or a gyroscope.

5. The gimbal according to claim 1, wherein the processor is further configured to:
obtain an adjustment matrix based on the first attitude data and the second attitude data; and
use the adjustment matrix to adjust the control direction of the first instruction to obtain the second instruction.

6. The gimbal according to claim 1, wherein the first attitude data is used to characterize a direction of a body coordinate system of the gimbal and the second attitude data is used to characterize a direction of a body coordinate system of the unmanned aerial vehicle.

7. The gimbal according to claim 6, wherein the first instruction corresponds to the body coordinate system of the unmanned aerial vehicle and the processor is further configured to:
based on the direction of the body coordinate system of the unmanned aerial vehicle and the direction of the body coordinate system of the gimbal, adjust the control direction to an adjusted control direction to obtain the second instruction, the adjusted control direction corresponds to the body coordinate system of the gimbal.

8. The gimbal according to claim 7, wherein the processor is further configured to:
in response to the direction of the body coordinate system of the unmanned aerial vehicle and the direction of the body coordinate system of the gimbal being different, adjust the control direction corresponding to the direction of the body coordinate system of the unmanned aerial vehicle to obtain the second instruction.

9. The gimbal according to claim 1, wherein the processor is further configured to:
obtain multiple instructions inputted by a user; and
synthesize the multiple instructions to obtain the first instruction.

10. The gimbal according to claim 9, wherein the multiple instructions include instructions inputted through a terminal device and/or instructions written through a software development kit (SDK).

11. An unmanned aerial vehicle, comprising:
a communication system for obtaining instructions to control movement of the unmanned aerial vehicle;
a power system;
a flight control system for providing, based on the instructions from the communication system, driving signals to the power system, wherein the power system drives the unmanned aerial vehicle based on the driving signals from the flight control system;
a gimbal including a first sensor configured to acquire first attitude data of the gimbal, a processor, a rotational axis mechanism, and a motor configured to drive the rotational axis mechanism; and
a sensing system including a second sensor,
wherein the processor is configured to:
obtain a first instruction to control movement of the gimbal;
obtain the first attitude data from the first sensor;
obtain second attitude data from the second sensor;
adjust a control direction of the first instruction based on the first attitude data and the second attitude data to obtain a second instruction for controlling the gimbal; and
control movement of the motor using the second instruction to drive the rotational axis mechanism so as to realize controlling of the gimbal.

12. The unmanned aerial vehicle according to claim 11, wherein the first sensor includes an accelerometer or a gyroscope.

13. The unmanned aerial vehicle according to claim 11, wherein the second sensor includes an accelerometer or a gyroscope.

14. The unmanned aerial vehicle according to claim 11, wherein the processor is further configured to:
obtain an adjustment matrix based on the first attitude data and the second attitude data; and
use the adjustment matrix to adjust the control direction of the first instruction to obtain the second instruction.

15. The unmanned aerial vehicle according to claim 11, wherein the first attitude data is used to characterize a direction of a body coordinate system of the gimbal and the second attitude data is used to characterize a direction of a body coordinate system of the unmanned aerial vehicle.

16. The unmanned aerial vehicle according to claim 15, wherein the first instruction corresponds to the body coordinate system of the unmanned aerial vehicle and the processor is further configured to:
based on the direction of the body coordinate system of the unmanned aerial vehicle and the direction of the body coordinate system of the gimbal, adjust the control direction to an adjusted control direction to obtain the second instruction, the adjusted control direction corresponds to the body coordinate system of the gimbal.

17. The unmanned aerial vehicle according to claim 16, wherein the processor is further configured to:
in response to the direction of the body coordinate system of the unmanned aerial vehicle and the direction of the body coordinate system of the gimbal being different, adjust the control direction corresponding to the direction of the body coordinate system of the unmanned aerial vehicle to obtain the second instruction.

18. The unmanned aerial vehicle according to claim 11, wherein the processor is further configured to:
obtain multiple instructions inputted by a user; and
synthesize the multiple instructions to obtain the first instruction.

19. The unmanned aerial vehicle according to claim 18, wherein the multiple instructions include instructions inputted through a terminal device and/or instructions written through a software development kit (SDK).

20. A gimbal for an unmanned aerial vehicle, comprising:
a processor;
a rotational axis mechanism;
a motor for driving the rotational axis mechanism; and
a first sensor for providing first attitude data of the gimbal;
wherein the processor is configured to:
obtain a first instruction to control movement of the gimbal;
acquire the first attitude data from the first sensor;
acquire second attitude data of the unmanned aerial vehicle connected to the gimbal;
determine whether directions of a body coordinate system of the unmanned aerial vehicle are same as respective corresponding directions of a body coordinate system of the gimbal;
in response to all of the directions of the body coordinate system of the unmanned aerial vehicle being same as all of the respective corresponding directions of the body coordinate system of the gimbal, use the first instruction to control movement of the motor to drive the rotational axis mechanism so as to realize controlling of the gimbal; and
in response to one of the directions of the body coordinate system of the unmanned aerial vehicle being different from a corresponding one of the directions of the body coordinate system of the gimbal:
adjust a control direction, corresponding to the one of the directions, of the first instruction based on the first attitude data and the second attitude data to obtain a second instruction for controlling the gimbal; and
control movement of the motor using the second instruction to drive the rotational axis mechanism so as to realize controlling of the gimbal.
